(19) United States
(12) Patent Application Publication
(10) Pub. No.: US 2005/0241239 A1
(43) Pub. Date: Nov. 3, 2005

(54) Abrasive composite tools having compositional gradients and associated methods

(76) Inventor: Chien-Min Sung, Tansui (TW)

Correspondence Address: Attn: M. Wayne Western;THORPE NORTH & WESTERN, LLP, P.O. Box 1219, Sandy, UT, 84091-1219, US

(21) Appl. No.: 10/837,242

(22) Filed: Apr. 30, 2004

(51) Int. Cl. C09C 1/68

(52) U.S. Cl. 51/308

(57) ABSTRACT

An improved abrasive composite tool having a compositional gradient is disclosed and described. The composite tool can include a first region including abrasive particles, a second region, and a transition region connecting the first and second regions. The transition region can have a compositional gradient from the first region to the second region. The transition region can have compositional gradients among materials such as metals, ceramics, diamond-containing materials, polymers, or composites of such materials. The compositional gradient can include multiple intermediate regions or may transition directly from the first region to the second region. Most often, the transition region can be formed by vapor deposition methods such as PVD and CVD. Advantageously, the transition region can be formed on an abrasive tool to provide improved chemical and/or mechanical erosion resistance.

### FIELD OF THE INVENTION

The present invention relates generally to coatings of various substrates, associated abrasive tools, and methods of producing such coatings and tools. Accordingly, the present invention involves the fields of chemistry, metallurgy, and materials science.

### BACKGROUND OF THE INVENTION

A wide variety of tools and manufacturing processes requires joining of two separate materials. Often materials to be joined have differing physical properties such as density, electrical conductivity, thermal conductivity and, of particular importance in the present discussion, thermal expansion coefficients. Two materials can be joined by a variety of known methods. For example, two materials can be joined by welding, brazing, gluing, or directly forming one material on another, e.g., by sintering, vapor deposition, or the like. Unfortunately, many applications of such joined materials include repeated exposure to temperature fluctuations. For example, abrasive tools, cutting tools, tribological tools, and semiconductor devices are all exposed to repeated heating and cooling cycles. As a result, the differing thermal expansion coefficients of joined materials results in frequent stress at the interface between these materials during such thermal fluctuations. Over time, this stress can result in mechanical failure at the interface such as spalling or delamination. In addition, mechanical stress can also cause failure at interfaces between materials.

Typical methods for alleviating such problems include providing one or more layers in between the materials to be joined. These intermediate layers can have properties which reduce stresses at interfaces between differing materials. However, such solutions still have distinct layers with discontinuous properties across the interfaces.

In addition, attachment of some materials to certain materials can be difficult. For example, formation of diamond or diamond-like materials directly on a metal substrate can be difficult. However, formation of such diamond materials on certain ceramics or carbide forming materials can be much easier.

Coatings of various tools can be desirable for several reasons such as chemical corrosion resistance, mechanical wear resistance, thermal resistance, improving friction properties, and the like. For example, U.S. Pat. No. 6,368,198 which is incorporated herein by reference, discloses CMP (chemical mechanical planarization) pad dressers with a protective coating. CMP pad dressers are commonly used in a highly corrosive environment which tends to degrade the metal substrate used to secure diamonds or other abrasives to a tool. The coating can help to lengthen the useful life of such tools by protecting the metal substrate from chemical corrosion. However, over time, the coatings tend to spall and separate from the underlying substrate, thus exposing the metal substrate to the corrosive environment.

Therefore, coatings, tools, and methods which display improved integrity, useful life, and wear properties continue to be sought.

### SUMMARY OF THE INVENTION

It has been recognized by the inventor that it would be advantageous to develop a method for producing coatings which provide improved surface properties as well as improved integrity.

In one aspect, the present invention resolves the problems set forth above by providing a composite tool including a first region including abrasive particles, a second region, and a transition region connecting the first and second regions. The transition region can have either a continuous or discontinuous compositional gradient from the first region to the second region. Further, each of the first and second regions can be formed of a metal, ceramic, diamond-containing materials, polymers, or composites of such materials. In one specific embodiment, the second region can be formed of a ceramic, diamond-containing materials, or composites of such materials.

In a detailed aspect of the present invention, the transition region can include a compositional gradient from a metal to a ceramic material. Common suitable ceramic materials can include SiC, Si₃N₄, Al₂O₃, AlN, ZrO₂, SiO₂, and their composites.

In still another detailed aspect of the present invention, the second region can be a diamond-containing material such as diamond-like carbon.

In an additional aspect of the present invention, the transition region can include at least one intermediate region. For example, the transition region can include multiple sub-gradients among one or more intermediate materials. One common embodiment includes forming a transition region from a stainless steel substrate to a ceramic material and then to a diamond-containing material such as diamond-like carbon.

In yet another aspect, the transition region can be vapor deposited.

In yet another aspect of the present invention, the composite tool can include abrasive particles on or partially embedded within the first region. The abrasive particles can be arranged randomly or in a predetermined pattern. Further, the abrasive particles can be superabrasive particles such as diamond, cBN, silicon carbide, silicon nitride, alumina, zirconia, and the like. The composite tool having abrasive particles therein can be configured for use as an abrasive tool such as a CMP pad dresser, cutting tool, or grinding tool.

In another aspect, the tools of the present invention can be produced by providing a substrate having a first region. A transition region can be deposited on the substrate such that the transition region has a continuous compositional gradient from the first region to a second region.

In one detailed aspect of the present invention, the transition region can be formed by either physical vapor deposition or chemical vapor deposition. As such, the deposition conditions can be variably adjusted to change the composition of deposited material as the transition region is deposited. Similarly, the first and second regions can optionally be formed by a vapor deposition process or can be pre-existing materials.

More specifically, a physical vapor deposition process can include providing at least two source materials, such that a first source material has a composition substantially that of the first region and a second source material having a composition substantially that of the second region. The rates of vapor deposition can be variably adjusted from each source material to produce the continuous compositional gradient.

In yet another detailed aspect, a third source material having an intermediate composition can be provided. During formation of the transition region the rates of vapor deposition from each source material can be variably adjusted such that the continuous compositional gradient has at a first gradient in composition from the first region to the intermediate composition and a second gradient from the intermediate composition to the second region. Any number of additional intermediate compositions can also be included by providing an additional source material and varying deposition rates of each source material to provide a continuous composition gradient.

There has thus been outlined various features of the invention so that the detailed description thereof that follows may be better understood, and so that the present contribution to the art may be better appreciated. Other features of the present invention will become more clear from the following detailed description of the invention, taken with the accompanying claims, or may be learned by the practice of the invention. Additional features and advantages of the invention will be apparent from the detailed description which follows which illustrates, by way of example, features of the invention.

### DETAILED DESCRIPTION

Reference will now be made to exemplary embodiments and specific language will be used herein to describe the same. It will nevertheless be understood that no limitation of the scope of the invention is thereby intended. Alterations and further modifications of the inventive features, process steps, and materials illustrated herein, and additional applications of the principles of the inventions as illustrated herein, which would occur to one skilled in the relevant art and having possession of this disclosure, are to be considered within the scope of the invention. It should also be understood that terminology employed herein is used for the purpose of describing particular embodiments only and is not intended to be limiting.

A. Definitions

In describing and claiming the present invention, the following terminology will be used.

The singular forms “a,” “an,” and “the” include plural referents unless the context clearly dictates otherwise. Thus, for example, reference to “a transition region” includes reference to one or more of such regions, and reference to “an alloy” includes reference to one or more of such alloys.

As used herein, “continuous compositional gradient” indicates a gradual change in composition, not a stepwise change or layered structure having distinct compositional or thermal expansion coefficient boundaries. Thus, the gradual change can include multiple transitions among various distinct intermediate materials or a direct gradual change from the first composition to the second target composition. As such, a “continuous compositional gradient” excludes substantially homogeneous materials, distinctly layered materials, or any materials having abrupt changes in composition or thermal expansion coefficient.

As used herein, “abrasive particles” refers to any particle which can provide abrading, cutting, polishing, grinding, or other material removal properties to a tool. Abrasive particles can include or consist of, any known abrasive material such as ceramics including aluminum oxide, zirconia, silicon nitride, carbides such as TiC, WC, SiC and the like, superabrasive particles such as diamond, diamond-like materials, and cBN, metals, super hard crystalline, or polycrystalline substance, or mixture of substances. Additional examples of such abrasive particles include sapphire, garnet, hardened steel, zirconia-alumina alloys, glass, colloidal silica, quartz, marble, feldspar, and the like.

As used herein, “vapor deposited” refers to materials which are formed using vapor deposition techniques.

As used herein, “vapor deposition” refers to a process of depositing materials on a substrate through the vapor phase. Vapor deposition processes can include any process such as, but not limited to, chemical vapor deposition (CVD) and physical vapor deposition (PVD). A wide variety of variations of each vapor deposition method can be performed by those skilled in the art. Examples of vapor deposition methods include hot filament CVD, rf-CVD, laser CVD (LCVD), metal-organic CVD (MOCVD), sputtering, thermal evaporation PVD, ionized metal PVD (IMPVD), electron beam PVD (EBPVD), reactive PVD, and the like.

As used herein, “thermal expansion coefficient mismatch” refers to the percent difference between the thermal expansion coefficients of two materials, i.e. |(α₂-α₁)|/α₁×100, where a is the linear thermal expansion coefficient.

As used herein, “region” refers to a volume of material which can be characterized by dimensions, composition, or other relevant properties. For example, the regions identified herein as first, second, transitional regions, and the like can be distinct volumes characterized by specific compositions, or can be characterized by a thickness or composition within a given range. Thus, in some embodiments, an abrasive composite tool can be formed in a single composite material having multiple regions therein characterized by variation in composition.

As used herein, “predetermined pattern” refers to a non-random pattern that is identified prior to formation of a tool, and which individually places or locates each abrasive particle in a defined relationship with the other abrasive particles. Further, such patterns are not limited to uniform grid or offset honeycomb patterns but may include any number of configurations based on the intended application.

As used herein, “uniform grid pattern” refers to a pattern of abrasive particles that are evenly spaced from one another in each of the x and y-directions.

As used herein, “substrate” refers to any material capable of use as a support for formation of the regions of the present invention.

As used herein, “alloy” refers to a solid or liquid solution of a metal with a second material. The second material may be a non-metal, such as carbon, a metal, or an alloy which enhances or improves the properties of the metal.

As used herein, “superabrasive particles” refer to a type of abrasive particles suitable for use in highly demanding applications and conditions. Examples of common superabrasive particles include, either natural diamond, synthetic diamond, polycrystalline diamond (PCD), cubic boron nitride (cBN), polycrystallihne cBN (PCBN), and the like.

As used herein, “diamond-containing materials” refer to any of a number of materials which include carbon atoms bonded with at least a portion of the carbons bonded in sp³ bonding. Diamond-containing materials can include, but are not limited to, natural or synthetic diamond, polycrystalline diamond, diamond-like carbon, amorphous diamond, and the like.

As used herein, “aperture” refers to an opening through a template surface which has a predetermined size and shape depending on the intended application. For example, the aperture size may be designed to accommodate a plurality of abrasives of a given mesh size. However, it is most often desirable to design the apertures such that only one abrasive particle is accommodated by each aperture.

As used herein with respect to an identified property or circumstance, “substantially” refers to a degree of deviation that is sufficiently small so as to not measurably detract from the identified property or circumstance. The exact degree of deviation allowable may in some cases depend on the specific context. Thus, for example, a source material which has a composition “substantially” that of a particular region may deviate in composition or relevant property, e.g., thermal expansion coefficient, by experimental error up to several percent, e.g., 1% to 3%.

As used herein, “substantially free of” or the like refers to the lack of an identified element or agent in a composition. Particularly, elements that are identified as being “substantially free of” are either completely absent from the composition, or are included only in amounts which are small enough so as to have no measurable effect on the composition.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited.

For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

B. The Invention

It is to be understood that the following description is only exemplary of the principles of the present invention, and should not be viewed as narrowing the appended claims.

The present invention includes a composite tool and methods for making a composite tool including a first region including abrasive particles, a second region, and a transition region connecting the first and second regions. The transition region can have a continuous or discontinuous compositional gradient from the first region to the second region. Each of the first and second regions can be formed of a variety of materials such as metals, ceramics, diamond-containing materials, polymers, and composites of these materials.

In one aspect of the present invention, the first region can be a pre-existing mass such as a tool substrate, sintered body, or other mass. Alternatively, the first region can be formed simultaneously with or in the same process as the transition region. In some embodiments, the first region can be an existing tool or substrate. For example, the first region can be formed of a wide variety of metals, ceramics, polymers, or diamond-containing materials.

In another aspect of the present invention, the second region can be almost any material which is suitable for a particular application such as metals, ceramics, diamond-containing materials, polymers, and their composites. Most commonly, the second region can comprise ceramic, diamond-containing materials, or composites of these materials. The second region can be a region which is exposed to working conditions such as when used in connection with abrasive tools. Alternatively, the second region can be attached to a separate substrate or material as part of a larger product, e.g., semiconductor components.

In one aspect of the present invention, the first or second region can comprise a ceramic material. The ceramic material can be almost any ceramic, although currently preferred ceramics include SiC, Si₃N₄, Al₂O₃, AlN, ZrO₂, SiO₂, and composites thereof. Suitable ceramics can include almost any ceramic used in abrasive tools such as, but not limited to, sintered ceramics, molten glass, enamels, and the like. Specific examples of such ceramics can include metal oxides, nitrides, carbides, borides, silicides, and the like. Non-limiting examples include silicon carbide, titanium carbide, tungsten carbide, chromium carbide, boron nitride, silicon nitride, aluminum nitride, corundum (aluminum oxide), zirconium oxide, yttrium oxide, chromium oxide, lanthanum boride, molybdenum silicide, borosilicate glass, kaolin, ceramics from polymeric precursors, and the like.

In still another detailed aspect of the present invention, the first or second region can comprise a diamond-containing material. Most often, the diamond-containing material can be diamond-like carbon (DLC).

Additionally, the first or second region can comprise a metal material. Non-limiting examples of suitable metal materials for forming the first or second region include metals selected from the group consisting of stainless steel, tool steel, super alloys, carbide forming braze alloys, iron alloys, silicon, refractory metals (e.g. W, Ti, Cr, etc.), and alloys thereof. In one specific example, the first region can comprise a carbide forming braze alloy. Suitable carbide forming braze alloys typically include a carbide forming metal such as iron, nickel, cobalt, manganese, chromium, silicon, copper, aluminum, titanium, vanadium, chromium, zirconium, molybdenum, tungsten and alloys of these metals. Iron, nickel, cobalt, manganese, chromium, copper, aluminum, and their alloys are currently the most preferred braze alloys. One particularly suitable class of braze alloys includes Fe—Ni alloys such as Fe—Cr—B—Si—Ni (commercially available from Wall Colmonoy Corp. as NICROBRAZ). Other exemplary carbide forming braze alloys include Invar alloys (Fe—Ni alloys such as Fe-30Ni-5Co and Fe-35Ni), Fe—Co, Ni—Mn—Co, Ni-20Cr, Cu—Sn—Ti, Cu—In—Ti, Cu—Mn—Si, Al—Ti, Al—Si, and the like.

Further, the first or second region can comprise a polymeric material. Suitable polymers can include almost any known organic resin, epoxy, and the like. Several non-limiting examples of suitable polymers include epoxy, polyimide, polyethylene terephthalate (MYLAR), polytetrafluoroethylene (TEFLON), polyurethane, polycarbonate, polyester, and mixtures thereof. However, other polymers can also be used such as, but not limited to, phenolics, acrylates, amino resins such as urea-formaldehydes and melamine-formaldehydes, aminoplast resins, alkyd resins, phenolic-latex resins, latex resins, epoxy resins such as bisphenols, isocyanates, isocyanurates, polysiloxane resins, acrylated epoxy resins, polyvinylidene fluoride, ceramers, and the like. In one specific aspect, the polymer can be an epoxy.

A transition region can be formed which connects the first and second regions. In one embodiment of the present invention, the transition region can have a continuous compositional gradient from the first region to the second region. The transition region can be formed using any number of methods which allow for production of a continuous compositional gradient. Alternatively, the transition region can have a discontinuous compositional gradient. In embodiments having discontinuous compositional gradients, it can be desirable to minimize thermal expansion mismatch across discontinuous boundaries. This can be accomplished by a stepwise change in composition which results in a corresponding stepwise change in thermal expansion which reduces stress at such boundaries. Preferably, the transition region can be vapor deposited on the first region. Vapor deposition is particularly desirable for application in coating of abrasive tools and semiconductor devices where thickness of the transition region is relatively small. Further, the transition region can be formed in a single continuous step or in discrete steps.

Vapor deposition can be accomplished by depositing materials from the vapor phase in which deposited material changes in composition as the transition region is deposited. A number of vapor deposition processes can be used in connection with the present invention. However, physical vapor deposition (PVD) and chemical vapor deposition (CVD) are currently preferred. In one specific aspect, the vapor deposition process can be a PVD process.

Both PVD and CVD methods are well known to those skilled in the art. PVD methods such as evaporation, sputtering, and arc methods can be used. Each process has inherent advantages and disadvantages given a particular situation. For example, evaporation can deposit materials slowly and relatively uniformly. Similarly, sputtering can deposit materials at a higher rate along a specific direction. Further, arc methods can also deposit materials at a high rate along a particular line of sight. Additionally, CVD methods deposit materials at high temperatures from gaseous sources to typically form crystalline films. In contrast, PVD methods typically deposit materials in an amorphous form. The amorphous deposited material can then optionally be annealed to form crystalline structures via known processes such as devitrification.

One method of achieving a compositional gradient using vacuum coating methods such as PVD and CVD can include providing a plurality of source materials, either as a solid or in a vapor phase. Depending on the specific coating vapor deposition method, the source materials can be deposited on a desired surface. In the methods of the present invention, each source material is chosen such that the vapor phase produced thereby corresponds substantially to a desired region of the final tool. For example, producing a transition region which has a compositional gradient directly from the first region to the second region can involve two source materials. A first source material can have a composition substantially that of the first region and a second source material can have a composition substantially that of the second region.

The coating conditions can be adjusted such that the rates of vapor deposition from each source material can be variably adjusted to produce the continuous or discontinuous compositional gradient. Coating conditions which can be adjusted depend on the specific process and can include, among other factors, DC currents, magnetic field strength, vapor source supply rates, vacuum level, and the like. The deposition of the transition region can include any process capable of forming a transition region having a first or originating composition and a second or target composition, such that a continuous gradient in composition exists from the originating composition of the first region to the target composition of the second region.

For example, in one embodiment of the present invention, a sputtering process can be used. A first source material can be provided as a metal cathode in a vacuum chamber with a gas such as argon or other similar gas. Applying a DC bias to the metal cathode forms argon cations which are strongly attracted to the metal cathode. As a result, metal from the cathode is sputtered as a vapor within the vacuum chamber which then deposits on surfaces within the chamber such as the first region. A second source material can be provided as a solid ceramic within the same vacuum chamber. The second source material can be sputtered using an RF capacitor. An optional magnetic field can be used to focus or direct electrons emitted from the cathode.

Thus, in accordance with the present invention, the first source material can initially be the sole source of deposited materials. Over time, the DC bias can be decreased as the RF capacitor is increased. Thus, as the transition region is deposited, initial deposited portions have a composition of the first source material, which then gradually transitions in composition. Ultimately, the second source material can be the sole source of deposited materials.

Optionally, if the second region has an intermediate composition which is a mixture, composite or alloy of the first and second source materials, the deposition process can be terminated at the point which substantially corresponds to the composition of the second region. The rate of variable adjustment can also depend on the desired thickness of the transition region and the intended application. Further, the compositional gradient need not be linear. Thus, the gradient in composition can be adjusted to provide specific properties to the final tool. For example, the first portions of the transition region can have a composition which varies substantially linearly from the first region to an intermediate composition. A predetermined thickness at the intermediate composition can then be formed, followed by a continuous gradient to the second region. Other variations in the composition profile can be formed by those skilled in the art based on an intended application. In some embodiments, it can be preferable to ensure that there are substantially no discontinuous or abrupt changes in thermal expansion coefficient or composition.

Alternatively, in some embodiments of the present invention, it may be desirable to form the transition region using processes such as, but not limited to, sprayed variable composition slurry, powdered methods having compositional gradients, etc. For example, slurries of a first source material and a second source material can be formed in suitable liquid vehicles, e.g., alcohols, water, or other volatile liquids. The slurries can then be sprayed onto the first region while variably adjusting the rates of slurry deposition for each source material to produce a desired compositional gradient. Upon removal of the liquid vehicle, the deposited materials can then be consolidated by known processes such as, but not limited to, sintering, hot isostatic pressing, cold isostatic pressing, infiltration, and the like. The resulting mass includes a transition region having a compositional gradient in accordance with the principles of the present invention.

Regardless of the specific process used to form the transition region, the transition region can include a wide variety of compositional gradient profiles. For example, the transition region can include at least one intermediate region having a composition different from either of the first or second regions. In order to produce such a material, a third source material can be included in the deposition process. The third source material can be deposited to form a portion of the transition region by variably adjusting deposition rates of each of the first, second and third source materials. Additional source materials can be included to form any number of intermediate regions, e.g., two, three, four, etc. When using a vapor deposition process to form the transition region, the rates of vapor deposition from each source material can be variably adjusted such that the continuous compositional gradient has at a first gradient in composition from the first region to the intermediate composition and a second gradient from the intermediate composition to the second region.

Thus, in some cases, the compositional gradient can include a plurality of compositional sub-gradients. For example, multiple gradations to various materials can be produced. In one embodiment, the transition region can include one intermediate region comprising a ceramic. In another embodiment, the transition region can have a continuous compositional gradient from a first metal to a first ceramic, then to a second metal, and finally to a second ceramic. Similarly, the transition region can have a compositional gradient from a metal to a first ceramic, then to a second ceramic, and then to an optional DLC material. In one detailed aspect of the present invention, the intermediate composition can be a ceramic and the second region can be a diamond-containing material. Any number of composition profiles can be designed based on the disclosure herein.

The transition region can have a wide variety of configurations and/or thicknesses. As a practical matter, the transition region can have a thickness of about 0.1 μm to about 1 mm, and preferably from about μm 1 to about 10 μm. The transition regions produced in accordance with the present invention allow for increased thicknesses without a loss in coating integrity. For example, a transition coating thickness prepared in accordance with the principles of the present invention can be formed which does not spall or delaminate from an underlying material or substrate. The actual thickness can vary considerably depending on the particular application and the thermal expansion mismatch between the first and second regions. For example, a greater thickness can be necessary in order to transition across a thermal expansion coefficient mismatch of 500% than would be required for a mismatch of 120%. Further, when forming a transition region on an abrasive tool, as described below, the thickness of the transition region can affect the abrasive properties of the tool. Typically, for abrasive tools the transition region can have a thickness from about 0.1 μm to about 10 μm, and preferably from about 1 μM to about 5 μm.

An additional consideration in formation of the transition region can be the thermal expansion coefficient mismatch between the first region and the second region. In one detailed aspect of the present invention, the first and second regions can have a thermal expansion coefficient mismatch of greater than about 5%. In a further detailed aspect, the thermal expansion coefficient mismatch can be from about 50% to about 500%. However, thermal expansion coefficient mismatch outside these ranges can also be accommodated. Specifically, there is no theoretical upper limit as to the degree of mismatch, if a thick enough transition region is deposited. Such a transition region can often require at least one additional source material and/or significantly increased thickness. As a very general guideline, metals can expand from about 5 to about 10 times more than ceramic, while polymers can often expand from about 2 to about 5 times more than metals.

The transition regions of the present invention are particularly useful when used in connection with various abrasive-containing tools. For example, the transition region can be formed on an abrasive tool containing abrasive particles. Such tools can include, but are in no way limited to, CMP pad dressers, polishing tools, cutting tools, grinding tools, and the like. Advantageously, transition regions which include compositions which do not include carbide formers or diamond-containing materials tend to not bond well with the abrasive particles. As a result, during initial use of the abrasive tool, portions of the transition region deposited on the abrasive particles may flake off. This initial flaking is sometimes referred to as “breakout.” However, the portions of the transition region formed on the substrate (or first region) remain strongly bonded and intact over extended periods of use.

Such abrasive tools can have abrasive particles on or partially embedded within the first region. Almost any known abrasive particles can be used. Appropriate transition region materials can then be chosen to achieve a desired tool wear. For example, the transition region can be chosen such that material tends not to form strong bonds with the abrasive particles. In this way the coating can be easily removed to expose abrasive particles for use without also weakening the coating over the substrate. Non-limiting examples of suitable abrasive particles can include diamond, cubic boron nitride, silicon carbide, silicon nitride, alumina, zirconia, and mixtures thereof. Other abrasive particles include ceria, silicon carbide, titanium diboride, boron carbide, tungsten carbide, titanium carbide, gamet, fused alumina zirconia, sol gel abrasive particles, titania, silica, metal oxides, metal carbides, and the like. In one preferred aspect, the abrasive particles are superabrasive particles. Most preferably, the abrasive particles are diamond particles. The abrasive particles can have a particle size which is suitable for the intended abrasive application. For example, lapping and polishing tools typically have a smaller abrasive particle size than sawing, cutting, grinding, dressing, and drilling tools. Generally, the abrasive particle size can range from about 1 μm to about 1 mm. In one specific embodiment, a dressing tool can have abrasive particle sizes from about 50 μm to about 200 μm. Regardless of the specific particle sizes, the transition region can often have a thickness which is significantly smaller than the abrasive particles, e.g., from about 0.1% to about 20%, and preferably from about 0.5% to about 10% of the abrasive particle size.

When forming a transition region as part of an abrasive tool, both the first and second regions can be independently selected from metals, ceramics, diamond-containing materials, polymers, and composites thereof. Thus, the transition region can be formed by any of the previously described processes such as vapor deposition, slurry, conventional sintering techniques or other known methods of achieving variable composition throughout a material.

An abrasive tool having abrasive particles in the first region can be formed using any number of known techniques. Such abrasive tools can include abrasive particles randomly distributed throughout the tool, randomly placed throughout the first region, or placed in a specific predetermined pattern. In many applications, placing abrasive particles in a predetermined pattern offers significant improvement in performance. Those of ordinary skill in the art will recognize a variety of ways for locating abrasive particles at desired locations on a surface or substrate. For example, U.S. Pat. Nos. 6,368,198; 6,286,498; 6,039,641; 6,193,770; 6,679,243; 2,876,086; 4,680,199; 4,925,457; 5,049,165; and 5,380,390, which are each incorporated herein by reference, describe production of abrasive tools having a predetermined pattern of abrasives. Generally, the above references describe using a variety of templates having apertures therein, meshes, or other structures to guide placement of individual abrasive particles to specific positions on a substrate to produce an abrasive tool. Such abrasive tools can be advantageously used as a starting material for the methods of the present invention. In this way, a substantially integral transition region can be formed on the abrasive tool. The transition region can provide improved resistance to chemical and/or mechanical erosion.

In one specific embodiment of the present invention, the first region can be an exposed surface of a CMP pad dresser having abrasive particles secured to a substrate. Although many CMP pad dressers can be used, those produced in accordance with U.S. Pat. No. 6,368,198 provide particularly good dressing properties and are the currently preferred CMP pad dressers to which the coatings of the present invention can be applied. CMP pad dressers including a transition region formed thereon can provide improved resistance to acid corrosion, i.e. typical CMP slurries have a pH around 3. Further, the transition region can prevent delamination or separation of the second region from the underlying pad dresser.

The abrasive particles can be secured to an abrasive tool using a wide variety of techniques such as brazing, gluing, electrodeposition, and the like. Typically, high quality abrasive tools can use a braze material which chemically bonds to the abrasive particles to reduce premature pull-out of abrasive particles. For example, a carbide forming braze alloy can be used for diamond abrasives. Suitable carbide forming braze alloys can include a carbide forming metal such as iron, nickel, cobalt, manganese, chromium, silicon, aluminum, titanium, vanadium, chromium, zirconium, molybdenum, tungsten and alloys of these metals. Iron, nickel, cobalt, manganese, chromium, and their alloys are currently the most preferred braze alloys. One particularly suitable class of braze alloys which is suitable for securing diamond particles to a metal substrate includes Fe—Ni alloys. One specific example of suitable Fe—Ni alloys is the NICROBRAZ line of braze alloys available from Wall Colmonoy Corp. such as Fe-35Ni. Once the abrasive particles are secured to a substrate, the exposed surface of the substrate can be the first region upon which a transition region can be formed in accordance with the principles previously described.

### EXAMPLES

The following examples illustrate exemplary embodiments of the invention. However, it is to be understood that the following are only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following examples provide further detail in connection with what is presently deemed to be practical embodiments of the invention.

### Example 1

A CMP pad dresser was produced in accordance with U.S. Pat. No. 6,368,198 using a stainless steel substrate and diamond particles having an average particle size of about 150 μm to about 180 μm. Further, the diamond particles were brazed to the substrate using a Ni—Cr alloy (NICROBRAZ LM). The CMP pad dresser was then placed in a vacuum chamber at a vacuum level of 0.35 Pa. A DC arc method was created using a magnetron to sputter stainless steel (316) cathode target material with the pad dresser acting as the anode. Further, radio frequency plasma was used to sputter an aluminum oxide source material.

The DC current was applied sufficient to begin deposition of stainless steel on the pad dresser. After an initial period, the RF capacitor was turned on and slowly ramped up to full power. Nearly simultaneously with the change in the RF capacitor, the DC current was gradually decreased. The total coating time was about three hours. The final CMP pad dresser had a transition region having a continuous compositional gradient from stainless steel to aluminum oxide and a thickness of about 3 μm.

The final composite coated CMP pad dresser was immersed in an acidic slurry (pH<3, as used in typical dressing operations) for 10 hours with no signs of corrosion. The aluminum oxide outer surface provided improved corrosion resistance and good mechanical abrasiveness.

### Example 2

A CMP pad dresser as in Example 1 was produced. The CMP pad dresser was then placed in a vacuum chamber. A DC current was connected to a stainless steel cathode with a standard cathodic arc trigger to provide a stainless steel source material. Further, a silicon carbide source material can be associated with an RF capacitor. The silicon carbide was used as a source material for an intermediate composition. In addition, a graphite cathode was also placed within the vacuum chamber.

The DC current was applied sufficient to begin deposition of stainless steel on the pad dresser. The RF capacitor was turned on and slowly ramped up to full power over several minutes. Nearly simultaneously with the change in the RF capacitor, the DC current was gradually decreased over several minutes. Subsequently, the DC current associated with the graphite cathode was ramped up to full power over several minutes. During ramp up of this DC current, the RF capacitor was gradually decreased.

The final CMP pad dresser had a transition region having a continuous compositional gradient from stainless steel to silicon carbide and a continuous compositional gradient from the silicon carbide to DLC. The total thickness of the transition region was about 4 μm. The DLC outer surface provided improved corrosion resistance and good mechanical abrasiveness. The stainless steel portion of the transition region provides a strong bond with the substrate, while the silicon carbide region provides carbide bonds with DLC.

### Example 3

A CMP pad dresser as in Example 1 was produced. The CMP pad dresser was then placed in a vacuum chamber. A DC current was connected to a stainless steel cathode with a standard cathodic arc trigger to provide a stainless steel source material. Further, a metal-carbon source material of nickel and carbon can be associated with an RF capacitor. The nickel carbide was used as a source material for an intermediate composition. In addition, a graphite cathode was also placed within the vacuum chamber.

The DC current was applied sufficient to begin deposition of stainless steel on the pad dresser. The RF capacitor was turned on and slowly ramped up to full power. Nearly simultaneously with the change in the RF capacitor, the DC current was gradually decreased. Subsequently, the DC current associated with the graphite cathode was ramped up to full power. During ramp up of this DC current, the RF capacitor was gradually decreased. The final CMP pad dresser had a transition region having a continuous compositional gradient from stainless steel to nickel and DLC and a continuous compositional gradient from the nickel and DLC to substantially pure DLC. The total thickness of the transition region was about 4 μm. The DLC outer surface provided improved corrosion resistance and good mechanical abrasiveness.

### Example 4

A CMP pad dresser as in Example 1 was produced. The CMP pad dresser was then placed in a vacuum chamber. A DC current was connected to a stainless steel cathode source material. Further, a nickel source material was placed in a resistance crucible within the vacuum chamber, i.e. thermal evaporation PVD. In addition, a gas inlet connected to silane and methane gas sources was provided to the vacuum chamber. The inlet was initially closed.

The DC current was applied sufficient to begin deposition of stainless steel on the pad dresser. At substantially the same time, the resistance crucible was turned on and slowly heated to full power. Nearly simultaneously with heating the resistance crucible, the DC current was gradually decreased. Thus, deposited materials gradually changed from predominantly iron and chromium to predominantly nickel. Subsequently, the pad dresser was heated and the inlet valve was opened to allow silane (a silicon source material) and methane (a carbon source material) into the reaction chamber along with hydrogen as a reducing agent. This CVD process began deposition of SiC along with residual stainless steel and initially high proportion of nickel. The resistance crucible was gradually cooled and the CVD conditions maintained. The total thickness of the transition region was about 5 μm. The SiC outer surface provided improved corrosion resistance and good mechanical abrasiveness.

Thus, there are disclosed improved methods and materials for forming coatings and tools with improved coating integrity and extended tool life. The above description and examples are intended only to illustrate certain potential embodiments of this invention. It will be readily understood by those skilled in the art that the present invention is susceptible of a broad utility and applications. Many embodiments and adaptations of the present invention other than those herein described, as well as many variations, modifications and equivalent arrangements will be apparent from or reasonably suggested by the present invention and the foregoing description thereof without departing from the substance or scope of the present invention. Accordingly, while the present invention has been described herein in detail in relation to its preferred embodiment, it is to be understood that this disclosure is only illustrative and exemplary of the present invention and is made merely for purpose of providing a full and enabling disclosure of the invention. The foregoing disclosure is not intended or to be construed to limit the present invention or otherwise to exclude any such other embodiment, adaptations, variations, modifications and equivalent arrangements, the present invention being limited only by the claims appended hereto and the equivalents thereof.

1. An abrasive composite tool, comprising:
a) a first region including abrasive particles;
b) a second region; and
c) a transition region connecting the first and second regions, said transition region having a compositional gradient from the first region to the second region.

2. The abrasive composite tool of claim 1, wherein the first region comprises a member selected from the group consisting of metal, ceramic, diamond-containing materials, polymers, and composites thereof.

3. The abrasive composite tool of claim 2, wherein the first region comprises a metal selected from the group consisting of stainless steel, tool steel, super alloys, carbide forming braze alloys, iron alloys, silicon, refractory metals, and alloys thereof.

4. The abrasive composite tool of claim 3, wherein the first region comprises a carbide forming braze alloy.

5. The abrasive composite tool of claim 4, wherein the carbide forming braze alloy comprises a member selected from the group consisting of iron, nickel, cobalt, manganese, chromium, and alloys thereof.

6. The abrasive composite tool of claim 2, wherein the first region comprises a polymer.

7. The abrasive composite tool of claim 1, wherein the transition region is a vapor deposited region.

8. The abrasive composite tool of claim 1, wherein the second region comprises a member selected from the group consisting of metal, ceramic, diamond-containing materials, polymer, and composites thereof.

9. The abrasive composite tool of claim 8, wherein the second region comprises a member selected from the group consisting of ceramic, diamond-containing materials, and composites thereof.

10. The abrasive composite tool of claim 9, wherein the second region comprises a ceramic material.

11. The abrasive composite tool of claim 11, wherein the ceramic material is selected from the group consisting of SiC, Si₃N₄, Al₂O₃, AlN, Zro₂, SiO₂, and composites thereof.

12. The abrasive composite tool of claim 9, wherein the second region comprises a diamond-containing material.

13. The abrasive composite tool of claim 12, wherein the diamond-containing material is diamond-like carbon.

14. The abrasive composite tool of claim 1, wherein the compositional gradient is a continuous compositional gradient.

15. The abrasive composite tool of claim 1, wherein the compositional gradient is a discontinuous compositional gradient.

16. The abrasive composite tool of claim 1, wherein the transition region further comprises at least one intermediate region.

17. The abrasive composite tool of claim 16, wherein the transition region includes one intermediate region comprising a ceramic.

18. The abrasive composite tool of claim 17, wherein the second region comprises a diamond-containing material.

19. The abrasive composite tool of claim 1, wherein the transition region has a thickness of about 0.1 μm to about 1 mm.

20. The abrasive composite tool of claim 1, wherein the first and second regions have a thermal expansion coefficient mismatch of greater than about 5%.

21. The abrasive composite tool of claim 1, wherein the abrasive particles are superabrasives selected from the group consisting of diamond, cubic boron nitride, silicon carbide, silicon nitride, alumina, zirconia, and mixtures thereof.

22. The abrasive composite tool of claim 21, wherein the abrasive particles are diamond.

23. The abrasive composite tool of claim 1, wherein the abrasive particles are placed in a predetermined pattern.

24. The abrasive composite tool of claim 1, wherein the abrasive tool is a CMP pad dresser.

25. A method of forming a composite coating on a substrate, comprising the steps of:
a) providing a substrate having a first region;
b) securing abrasive particles to the first region; and
c) depositing a transition region on the substrate such that the transition region has a compositional gradient from the first region to a second region.

26. The method of claim 25, wherein the first region and second region each comprises a member independently selected from the group consisting of metal, ceramic, diamond-containing materials, polymers, and combinations thereof.

27. The method of claim 26, wherein the second region comprises a member selected from the group consisting of metal, ceramic, diamond-containing materials, and combinations thereof.

28. The method of claim 27, wherein the second region comprises either a ceramic material or a diamond-containing material.

29. The method of claim 28, wherein the second region comprises a ceramic material.

30. The method of claim 29, wherein the ceramic material is selected from the group consisting of SiC, Si₃N₄, Al₂O₃, AlN, ZrO₂, SiO₂, and composites thereof.

31. The method of claim 28, wherein the second region comprises a diamond-containing material.

32. The method of claim 26, wherein the first region comprises a metal selected from the group consisting of stainless steel, tool steel, super alloys, carbide forming braze alloys, iron alloys, silicon, refractory metals, and composites thereof.

33. The method of claim 26, wherein the first region comprises a polymer.

34. The method of claim 25, wherein the transition region has a thickness of about 0.1 μm to about 1 mm.

35. The method of claim 25, wherein the first and second regions have a thermal expansion coefficient mismatch of greater than about 5%.

36. The method of claim 25, wherein the step of depositing includes a vapor deposition process.

37. The method of claim 36, wherein the vapor deposition process is controlled such that deposited material changes in composition as the transition region is deposited.

38. The method of claim 36, wherein the vapor deposition process is a physical vapor deposition or chemical vapor deposition.

39. The method of claim 38, wherein the vapor deposition process is a physical vapor deposition process which includes:
a) providing at least two source materials, such that a first source material has a composition substantially that of the first region and a second source material having a composition substantially that of the second region; and
b) variably adjusting rates of vapor deposition from each source material to produce the compositional gradient.

40. The method of claim 39, wherein the second region comprises either a ceramic or a diamond-containing material.

41. The method of claim 40, wherein the second region comprises a ceramic material selected from the group consisting of SiC, Si₃N₄, Al₂O₃, AlN, ZrO₂, SiO₂, and composites thereof.

42. The method of claim 39, wherein the transition region has a thickness of from about 0.1 μm to about 1 mm.

43. The method of claim 39, further comprising a third source material having an intermediate composition and wherein the rates of vapor deposition from each source material are variably adjusted such that the continuous gradient has at a first gradient in composition from the first region to the intermediate composition and a second gradient from the intermediate composition to the second region.

44. The method of claim 43, wherein the intermediate composition comprises a ceramic and the second region comprises a diamond-containing material.

45. The method of claim 25, wherein the compositional gradient is a discontinuous compositional gradient formed in discrete steps.

46. The method of claim 25, wherein the compositional gradient is a continuous compositional gradient.

47. The method of claim 25, wherein the abrasives are superabrasive selected from the group consisting of diamond, cubic boron nitride, silicon carbide, silicon nitride, alumina, zirconia, and mixtures thereof.

48. The method of claim 25, wherein the step of securing is accomplished by brazing using a carbide forming braze alloy.

49. The method of claim 25, wherein the abrasive particles are secured to the substrate in a predetermined pattern.
